(19) United States
(12) Patent Application Publication
(10) Pub. No.: US 2013/0219254 A1
(43) Pub. Date: Aug. 22, 2013

(54) 2D CODE LINKED TO CUSTOMIZED WEB PAGE WITH USER-UPLOADED CONTENT

(71) Applicants: James Edward Kashork, Spokane, WA (US); Catherine Daniel Kashork, Spokane, WA (US)

(72) Inventors: James Edward Kashork, Spokane, WA (US); Catherine Daniel Kashork, Spokane, WA (US)

(73) Assignee: ConneQtive, Inc., Spokane, WA (US)

(21) Appl. No.: 13/401,380

(22) Filed: Feb. 21, 2012

(51) Int. Cl. G06F 17/00

(52) U.S. Cl. 715/205; 715/234

(57) ABSTRACT

Described herein are techniques related to delivering content and more particularly delivering customized web content with the aid of two-dimensional codes. This Abstract is submitted with the understanding that it will not be used to interpret or limit the scope or meaning of the claims.

### BACKGROUND

Companies, organizations, individuals, and other entities sometimes try to entice business from others by delivering gifts to these other persons. In addition, many individuals wish to express their feelings, thoughts, etc. with greeting cards, gifts, and the like. However, with conventional approaches those who originate such communications must choose between a necessarily finite group of gifts, greeting cards, etc.

Moreover, these limited delivery mechanisms provide little or no opportunity for the creator of such communications to individualize or customize the content contained therein. That limited content can only be accessed in hard-copy form in conventional situations. Purchasers of greeting cards, for instance, often spend large amounts of time searching for the card that is “just right” for the recipient, for the occasion, etc. Gift buyers face similar challenges when selecting their purchase.

### BRIEF DESCRIPTION OF THE DRAWINGS

FIG. 1 illustrates various gifts.

FIG. 2 is a schematic diagram of a system for delivering mobile web pages.

FIG. 3 is a block diagram illustrating an example website for linking a two-dimensional (2D) code to a customized web page containing user-selected content.

FIG. 4 illustrates a template for building customized web pages.

FIG. 5 illustrates 2D-code icons.

FIG. 6 illustrates a process for delivering mobile content.

FIG. 7 illustrates a process for creating and receiving mobile content.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies related to delivering content and more particularly delivering mobile content via two-dimensional (2D) codes.

The technologies described herein include a generation of a gift and/or gift card with an indicator (e.g., an icon) printed thereon that, when scanned by a mobile device (e.g., smartphone), directs the mobile device to a customized web page. To accomplish this, a customer accesses a centralized server (or servers) offering a web-page-creation website. That website is provided by a gift-delivery-facilitation entity. Such an entity may be a florist, other gift delivery business, or a facilitator that helps such gift-delivery businesses. The customer may get to the website via a link received in an email from such business. As used herein, “originator” refers to the gift-delivery-facilitation entity providing, managing, and/or maintaining the centralized servers and its web-page-creation website.

With the tools offered on the website, the customer creates a customized mobile web page. The customized web page is intended to be viewed by a recipient of a to-be-delivered gift and/or gift card. The originator accepts customer-selected content for inclusion in the customized web page via the web-page-creation website. The originator builds customized web page using the customer-selected content, obtaining/generating a 2D (two-dimensional) code, and associates that 2D code with the customized web page. These 2D codes include, but are not limited to the QR® (quick response) code, the PDF417 code, the Data Matrix® code, and the Maxi Code.

A 2D-code icon is generated. The 2D-code icon is a physical manifestation or representation of the 2D code. Typically, the 2D-code icon is printed on a gift card, label, and/or the like. If there is a to-be-delivered gift, the card, label, and/or the like is attached to, affixed to, set next to, etc. the gift before, as, or after it is delivered to the recipient.

Some of the implementations described herein are called “wholesale” implementations. With the “wholesale” implementations, the originator delivers the 2D-code icon and/or 2D code itself to a third party. That third party delivers the gift with the printed 2D-code icon affixed, attached, etc. thereto to the recipient. In some instances, the third party is a florist business provided 2D-code icon via an email from a gift-delivery-facilitation entity. In other instances, the third party is one of a several co-owned or commonly associated gift-delivery businesses that receive the 2D-code icon from their central or regional corporate headquarters.

Some of the implementations described herein are called “retail” implementations. With the “retail” implementations, the originator delivers the 2D-code icon and/or 2D code itself to the customer. In turn, the customer prints the 2D-code icon and delivers the gift with the printed 2D-code icon affixed, attached, etc. thereto to the recipient.

In the “wholesale” implementations, the third parties may pay a service or subscription fee to the gift-delivery-facilitation entity to use their web-page customization and associated 2D code service. In the “retail” implementations, the users may pay a service or subscription fee to the originator to use their web-page customization and associated 2D code service.

In some implementations, the customer can customize the 2D-code icon and the originator can accept the customization of the 2D-code icon from the customer. Furthermore, the originator can build the mobile web page using the customer-selected content and a template into which the originator places that content. In some implementations, the originator can generate the 2D code and, if desired, could customize the 2D-code icon with a (company, family, personal, etc.) monogram. The originator can print out the 2D-code icon as part of a gift, greeting card, etc. and (if desired) deliver it to a recipient.

One or more described implementations provide systems that include servers configured to perform such processes. Such systems can include printers in communication with the servers to print the 2D-code icons. Systems of embodiments can include delivery services for delivering the printed 2D-code icons.

Example Gift and Gift Cards with 2D-Code Icons

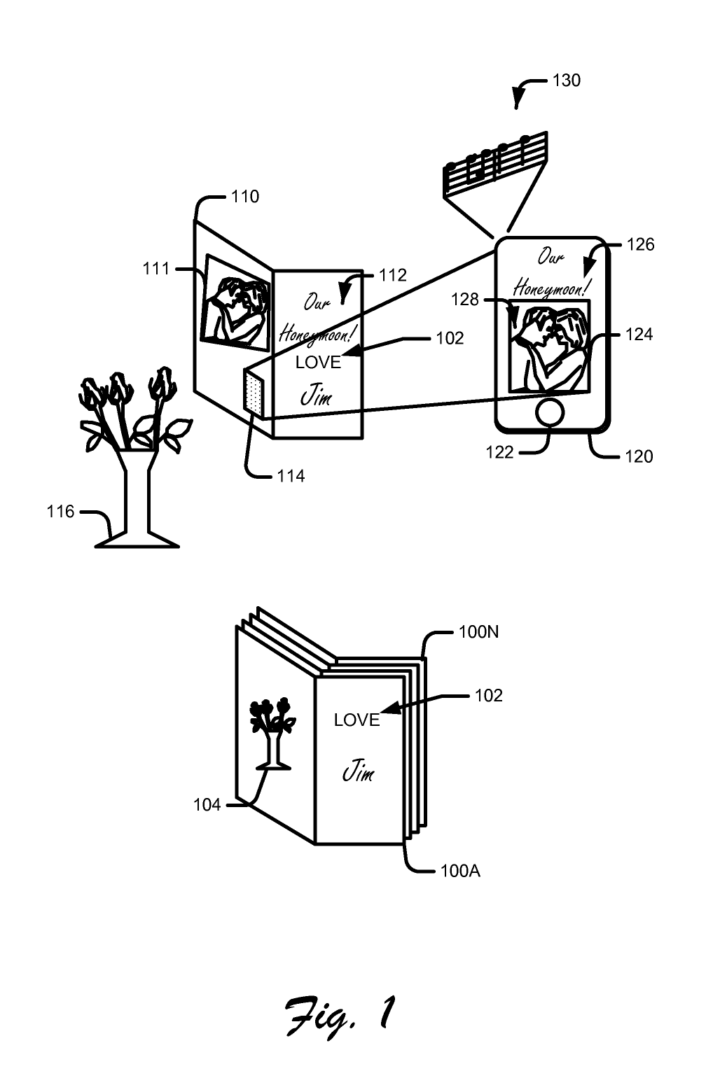

FIG. 1 illustrates various example gifts and gift cards with 2D-code icons printed thereon. More specifically, FIG. 1 illustrates conventional cards 100A to 100N (e.g., greeting or gift cards). Each card includes one of a number of common messages 102. These messages 102 deal with a variety of themes and come in a variety of styles. For instance, some conventional cards 100 deal with business-related issues such as grand opening invitations, “we're moving” announcements, special offers, thank you messages, etc. While some variety might exist in this group of common messages 102, the publisher of the line of conventional cards 100 determines which common messages 102 are offered. Thus, the customer (or a user) must select from this finite range of pre-determined common messages 102 when selecting conventional cards 100.

Many conventional cards 100 deal with personal issues. For instance, some conventional cards 100 express holiday greetings. With the proliferation of holidays of recent years, many types of holiday-related greeting cards exist. For instance, customers can find conventional cards for New Years, Valentine's Day, Easter, the Fourth of July, Thanksgiving, Christmas, Hanukkah, Mother's Day, Father's Day, Grandparent's Day, Secretary's Day, etc. These conventional cards 100 typically include common traditional greetings associated with these holidays. Additionally, conventional cards 100 exist that contain common messages 102 related to graduations, newborns, weddings, anniversaries, and other events related to a particular individual.

Some of the common messages 102 can be short and to the point (i.e., “Happy Birthday”). However, some of the messages 102 can elaborate on such ideas and/or contain humorous or thought-provoking sayings. Some common messages 102 can extend to the length of a paragraph or more such as with some anniversary cards. Despite the illustrative variety available in conventional cards 100 as discussed above, the variety remains limited by the selections made by the publisher of the cards. The customer, other than selecting from such common messages 102, has no opportunity to alter the message 102 (except by writing on the card).

Furthermore, many conventional cards 100 include some similarly limited or common graphic features 104. These common graphic features 104 run the gamut from simple graphical designs to photographs of people, scenes, etc. Fanciful or artistically created common graphic features 104 sometimes appear in various conventional cards 100 too. Again, the publisher of these conventional cards 100 selects the common graphic features 104 therein. Thus, conventional cards 100 allow the possibility that one recipient will receive two similar (or even the same) cards during a given event in their life, the life of their business, or other events/activities.

In accordance with embodiments, FIG. 1 also illustrates a 2D greeting card 110 which allows a user to select the messages and content which they desire to have in (or associated with) that greeting card. More specifically, FIG. 1 illustrates that the 2D greeting card 110 includes user-selected content 111, a user-created message 112, and a 2D-code icon 114 or facsimile thereof. Note that gifts 116 can be associated with either the conventional card 100 or the 2D greeting card 110 or both.

In the current embodiment, therefore, the user (a customer for instance) selects the user-selected content 111 and causes the provider of the 2D greeting card 110 to associate that user-selected content 111 with the 2D greeting card 110. In some cases, that association can be electronic (via the Internet or some other wide area network) while in other cases that association can be by way of physically placing the user-selected content 111 on the 2D greeting card 110 in some way. For instance, the user-selected content 111 could be printed on cardstock or paper along with other features of the 2D greeting card 110.

Moreover, that user-selected content 111 can be selected from files on the user's personal computer, laptop computer, tablet, notepad, cellular phone, etc. The user could even select content from the Internet and cause it to be associated with the 2D greeting card 110. Similarly, the user can create the user-created message 112 and cause it to be associated with the 2D greeting card 110. As a result, the user can customize the 2D greeting card 110. Note that the user could begin the customization process with a blank template and fill it with various content which they have available.

With continuing reference to FIG. 1, the 2D-code icon 114 allows the user-selected content 111 and user-created message 112 to be electronically associated with the 2D greeting card 110. More specifically, the 2D code encoded within the 2D-code icon 114 allows users (notably recipients and others) to scan or read the 2D code with their mobile devices (such a smartphone) and receive thereon web pages containing the user-selected content 111 and/or user-created messages 112. Of course, the mobile devices 120 might include an application or other functionality to scan 2D-code icons 114 and link to websites associated therewith. Functionality for scanning 2D-code icons 114 and linking to associated websites is available in some smartphones such as iPhones®, Android™ phones, etc.

FIG. 1 further illustrates the use of the 2D-code icon 114. More specifically, FIG. 1 shows that a mobile device 120 with user controls 122 and a display 124 can be used to display user-created messages 126 and/or custom content 128 along with custom audio-visual (AV) content 130. Thus, a user can select the user-selected content 111 and create the user-created message 112 and a system (disclosed further herein) builds the 2D greeting card 110 using that information and associates a 2D code therewith. Then, when the 2D-code icon 114 on the 2D greeting card 110 is read (and the associated link followed) by a mobile device 120, that information is output in a web page as the user-created message 126, the custom content 128, and/or the custom AV content 130. On that note, it might now be interesting to discuss some aspects of such systems.

### Example Distributed System

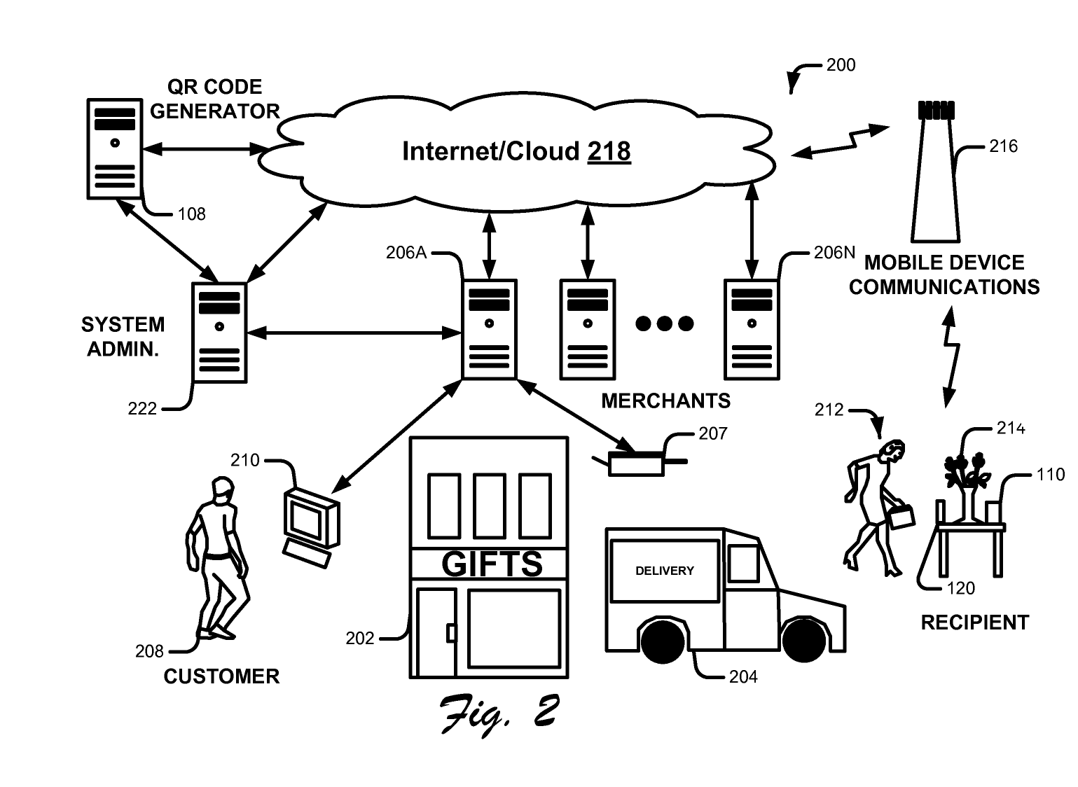

FIG. 2 is an example schematic diagram of a distributed system employing the techniques described herein. The system 200 includes or communicates with an entity 202. The entity 202 could be any type of retail establishment such as a florist, a jewelry store, a restaurant, a professional sports team, etc. Moreover, other organizations could serve as the entity. For instance, charities, corporations, clubs, associations, etc. could be the entity 202. The entity 202 could even be a person. However, in the current embodiment, the entity 202 is a gift store and has a delivery service 204 (illustrated as a delivery vehicle by FIG. 2). The entity 202 also has a server 206 connected to a wide area network and a printer 207. Of course, many entities 202 with corresponding servers 206A to 206N could be included in system 200.

In many situations, users 208 (such as customers) access the server 206 via their personal computers 210, mobile devices, entity-related kiosks, etc. and place orders with the entity 202. For instance, one user 208 might desire to buy another user (recipient 212) a gift 214. In addition to ordering the gift 214 (and its delivery) via the server 206, the user 208 can also purchase a 2D greeting card 110 to be delivered therewith. The server 206 builds the 2D greeting card 110 using the user-selected content 111 and/or user-created message 112, which the user 208 selects and/or creates using the personal computer 210. The server 206 prints out the resulting 2D greeting card 110 on printer 207. From there the delivery service 204 can deliver the hard copy 2D greeting card 110 (with or without a gift 214) to the recipient 212. In the alternative, or in addition, the server 206 could electronically deliver the 2D greeting card 110 to the recipient 212 via the recipient's mobile device 120 or some other device.

With continuing reference to FIG. 2, the drawing also illustrates a mobile device communications system 216 (e.g., cellular telephony system), the Internet 218, a 2D code generator 220, and a system operator 222. In conjunction with the mobile device 120, the mobile device communications system 216 allows the recipient 212 to read the 2D code encoded in the 2D-code icon 114 of the 2D greeting card 110. That 2D-code icon 114 can encode an Internet-related uniform resource locator (URL) or other address at which the custom content 124, user-created message 126, and/or custom AV content 130 can be accessed. For instance, the URL might link to a web page containing such information or even a web page configured for display on mobile devices 120 (i.e., a mobile web page). The recipient's mobile device 120 can access those URLs or that web page over the Internet 218 (which links the various portions of system 200 together) and retrieve that information.

In some embodiments, the server 206 can rely on the 2D code generator 220 to generate the 2D codes upon its request. Here, the 2D code generator 220 happens to be an independent third party. However, in some embodiments, the server 206 can be configured to generate 2D codes if desired.

FIG. 2 also illustrates the system administrator 222. The system administrator 222 (or its server) can perform the functions of the servers 206 to 206N. For instance, the system administrator 222 can build and deliver (at least electronically) 2D greeting cards 110 and/or act as an entity 202 (or retailer). In addition, the system administrator 222 can (via contractual arrangements with the entities 202) maintain quality control over the various aspects of system 200, the 2D greeting cards 110 built thereby, the custom content 126, 128, and/or 130 therein, etc.

In embodiments wherein the servers 206 perform such functions (rather than the system administrator 222) under contract with the system administrator 222, the systems 200 can be deemed “wholesale” systems. In this instance, that means that the system administrator 222 licenses rights to offer 2D greeting cards 110 to various retailers. In this regard the system administrator acts in a manner somewhat like that of a wholesaler. In other wholesale implementations, the system administrator acts as an entity 202 offering 2D greeting cards 110. In some implementations, the customer 208 and entity 202 are combined because, for example, the customer prints his own gift cards to be delivered with the gift. Of course mixed wholesale and retail systems 200 are within the scope of the disclosure.

### Example Web-Page-Customization Website

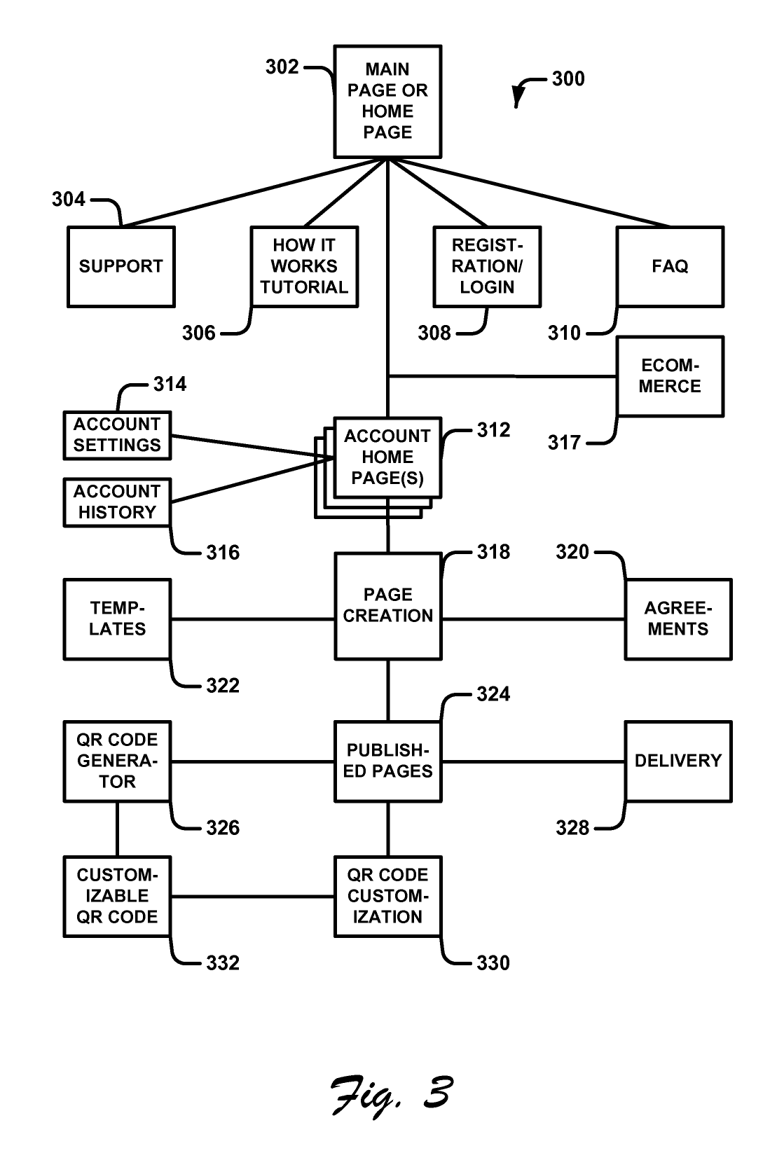

FIG. 3 is a block diagram illustrating a logical organization of an example website for linking the 2D code to a customized web page containing user-selected content. Much of the website 300 can be implemented on a server 206 in conjunction with various aspects of system 200 (see FIG. 2). The website 300 includes a main page 302, a support page 304, a tutorial page 306, a registration page 308, a FAQ page 310, and an account page 312 (for each user 208). These pages 302, 304, 306, 308, 310, and 312 cooperate to allow users 208 who might desire to purchase 2D greeting cards 110 to do so. Thus, they allow the user 208 to register with the website 300, login/logout, learn about the website 300 and related services, and obtain technical and administrative support if desired. The website 300 also has provisions to store account settings 314 and account histories 316 for various users 208.

The website 300 of the current embodiment also includes a page creation page 318 which users 208 can access to build 2D greeting cards 110. However, if the entity 202 so desires, access to that functionality can be limited/allowed per agreements 320 stored in (or otherwise governing) the website 300 (or, rather, user access thereto). The page creation page 318 can accept user-selected content 111 and user-created messages 112 for inclusion in one or more templates 322 if the corresponding agreement 320 allows such access privileges. The templates 322 of the current embodiment (once populated with the user-selected content 111 and/or user-created messages 112) can be stored as published web pages 324. Recipients 212 can access these published web pages 324 via the 2D-code icons 114 in the 2D greeting cards 110 which they receive.

The website 300 can also include a link to a 2D code generator 326. Thus, when a new web page is initiated, built, published, etc., the website 300 can request a 2D code from the 2D code generator 326. The 2D code generator 326 can return a 2D code in response to such requests. In addition, or in the alternative, the website 300 can include a link to a delivery system 328. That link can be by way of the printer 207 (see FIG. 2) or can be an electronic delivery system 328.

Website 300 can also allow users to customize 2D-code icons via a 2D code customization module 330. Using the 2D code customization module 330, users 208 can alter the appearance, size, color, etc. of the 2D-code icons 114 that are associated with their 2D codes. In some embodiments, the 2D code customization module 330 allows users 208 to insert or mold monograms into the 2D-code icons. That functionality can be included in the servers 206, in the server of the system administration 222, shared between these entities, etc. Moreover, website 300 can store various customized 2D-code icons 332.

### Example Template

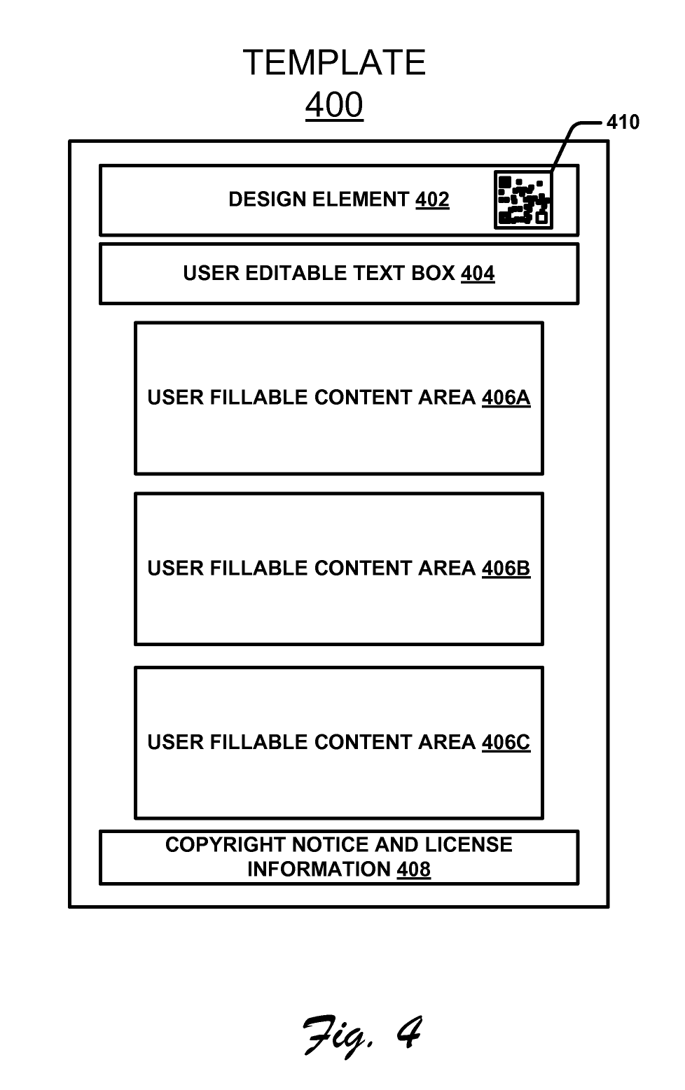

FIG. 4 illustrates a template for building customized web pages. As disclosed with reference to FIG. 3, website 300 of some embodiments includes templates 400 for various 2D greeting cards 110. These templates 400 can reflect various artistic features in addition to providing places for user-selected content 111, user-created messages 112, etc. to be displayed in the published web pages 324. Thus, some templates 400 include a design element 402 that is often associated with some theme. That theme can be any theme associated with conventional cards 100 (see FIG. 1) or other types of themes. For instance, the design element 402 could display hearts or flowers against a pink, red or maroon background for a theme associated with Valentine's Day.

Near the design element 402 of some embodiments, the template 400 can include a text box 404. That text box 404 can be used by users 208 to enter their user-created messages 126 for inclusion in their 2D greeting card 110. In addition, or in the alternative, the template 400 includes one or more user-fillable content areas 406A-C. These areas 406 allow the user 208 to place user-selected content 111 on the 2D greeting card 110. For instance, the website 300 could be configured to allow users 208 to drag and drop content from the directories on their personal computers to these areas. Furthermore, the templates 400 (or page creation page 318) could be configured to recognize the type of content being added thereto. For instance, if a user 208 drops a piece of audio content into an area 406, the template 400 could respond by storing that audio content and placing a thumbnail or other icon linked to the audio content in the particular area 406 involved.

Template 400 could also include a text box 408 containing a copyright notice and license. The notice could warn the user 208 not to select content for inclusion in the 2D greeting card 110 unless that user owns the copyright or has a license thereto. The text box 408 can also include the terms of a license from the user 208 to the website 300 (or entity 202) to reproduce the content that the user 208 selects for inclusion therein. Text box 408 could be non-modifiable (at least from the viewpoint of user 208).

With continued reference to FIG. 4, the template 400 can include a placeholder 410 for a 2D-code icon. In this manner, users 208 would be less inclined to unknowingly over-write the area of the 2D greeting card 110 at which the 2D-code icon 114 will appear. That placeholder 410 can reserve enough space on the template 400 for other elements associated with the 2D-code icon 114 too. Of course, once a 2D code becomes associated with a particular 2D greeting card 110 (or web page) that placeholder 410 can be replaced by the 2D-code icon 114 or a facsimile thereof.

### Example 2D-Code Icons

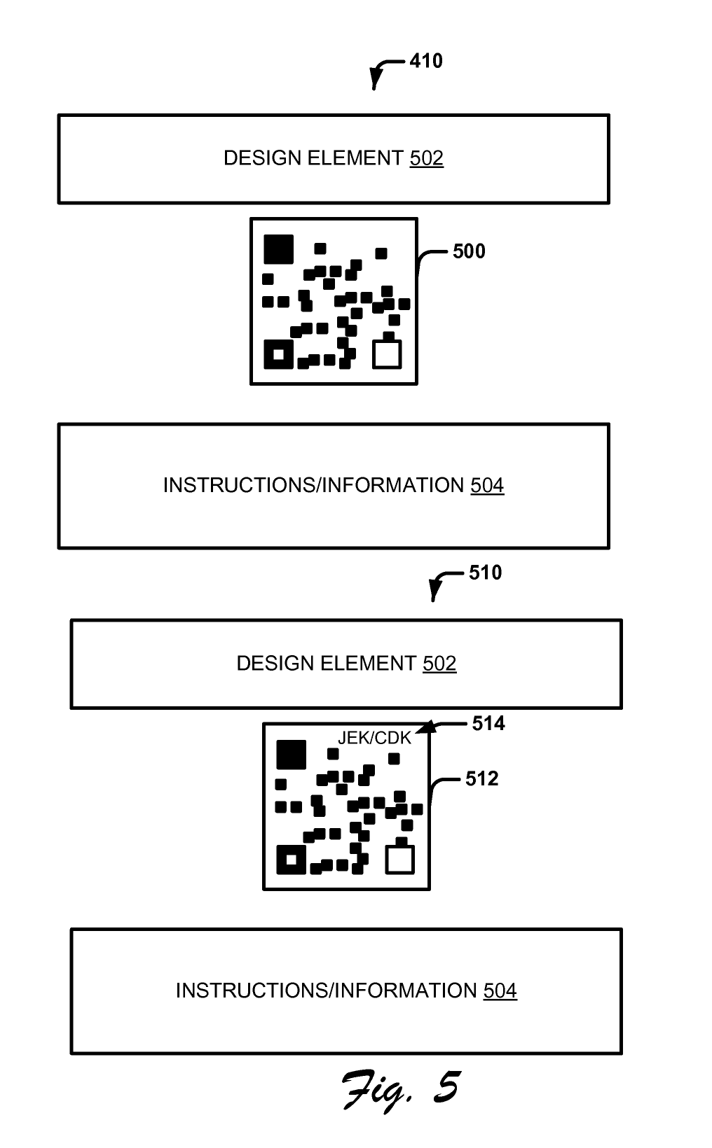

FIG. 5 illustrates example 2D-code icons. More specifically, FIG. 5 shows that the placeholder 410 of FIG. 4 can provide room in the template 400 for a 2D-code icon 500, an associated design element 502, and an instructions/information text box 504. The 2D-code icon 500 can be a graphical representation of a 2D code. The 2D code itself can be assigned by the 2D code generator 220 and the 2D-code icon 500 can reflect the appearance of the 2D code as reduced to physical form by (for illustrative purposes) a printer 207.

Since some recipients 212 might not be familiar with 2D codes, and/or for other reasons, the placeholder 410 can include a design element briefly announcing what the 2D-code icon 500 is, what it does, etc. The design element 502 can also serve to call attention to the 2D-code icon 500 in the published web page 324. Additionally, the instructions/information text box 504 can provided information about the 2D-code icon and/or instructions on how to use it. These instructions can be part of the template 400, which can be modified by the user 208, or the user 208 can create these instructions themselves.

FIG. 5 also illustrates a customized 2D icon 512. In the current embodiment, the customized 2D icon 512 includes a monogram 514 inserted into an otherwise white or blank space of the icon. This particular monogram happens to be the initials of certain users 208. However, other customizing monograms, artwork, etc. could be added to the customized 2D-code icon 512. In addition, or in the alternative, the customized 2D-code icon 512 could have had other features (such as its color, size, etc.) customized if desired. Having discussed some aspects of the system 200 and website 300 it might now be interesting to disclose aspects of processes associated with 2D greeting cards 110.

### Example Processes

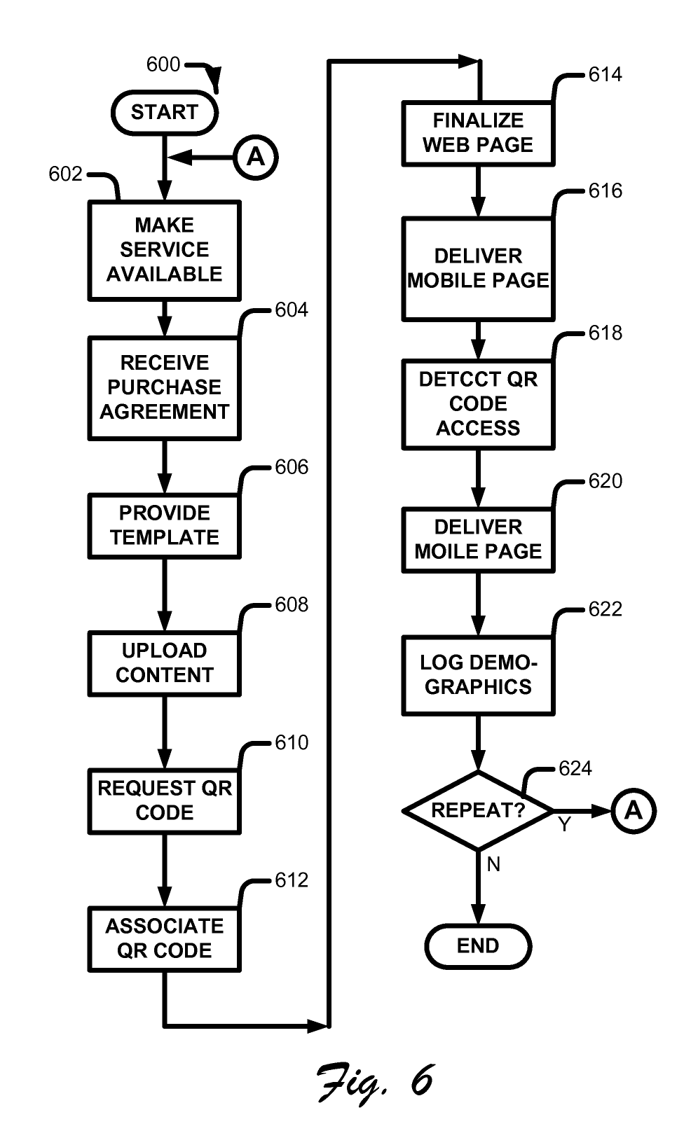

FIG. 6 illustrates an example process for delivering mobile content. Process 600 includes various activities such as making the website 300 and its services, functionality, etc. available to potential purchasers and other users 208. The system 200 can do so using the Internet 218, a wide area network, or some other system for disseminating information. See reference 602.

At some point it might happen that a user 208 wishes to avail themselves of the services provided by website 300. In such cases, the system 200 can allow that user 208 access to the website 300 for creating web pages with custom content. Once an agreement 320 exists which grants access to the page creation page 318, the system 200 can allow the corresponding user 208 access thereto. For instance, the user 208 could have purchased the services of the website 300 for the creation of one or more web pages and corresponding 2D greeting cards 110. Moreover, the website 300 could have received notification of that purchase. See reference 604.

Process 600 can include the system 200 providing the user (if authorized in some embodiments) a template 400 for a web page as illustrated at reference 606. For instance, the user 208 might have browsed an online catalogue of the templates 400 according to various themes and then selected a particular template 400 there from. Using the template 400 and the page creation page 318, the user 208 could select content from their personal collection and upload it to the page creation page 318. See reference 608.

At some point, the website 300 can request a 2D code for the web page upon which the user is/has worked. See reference 610. Typically, that point can be the point at which the user 208 “accepts” or “submits” the web page of interest. However, the website 300 could request the 2D code when the user invokes a template 400 or at other times. As part of the request for the 2D code, the website 300 can specify that the particular web page at issue (or its URL) should be associated with the 2D code. That association can be made by the 2D code generator 220 or in some other convenient fashion. See reference 612. At reference 614, process 600 provides for the user 208 finalizing the web page that the user 208 has undertaken to build.

The website 300 can also be configured to deliver or publish such web pages and can configure these published web pages 324 as mobile web pages. The website 300 can also print out the 2D greeting card 110 with its corresponding features via printer 207. If desired, the entity 202 can then deliver the printed 2D greeting cards 110 using, for instance, delivery service 204. In the alternative, or in addition, an electronic version of the 2D greeting card 110 can be sent to the recipient 212. See reference 616.

Thus, with the 2D greeting card 110 eventually reaching a recipient 212, it is likely that the 2D-code icon 114 will be scanned by that recipient 212 and that the URL decoded there from will be accessed or visited by that recipient 212. Website 300 can, in many cases, sense that access is being requested to the published web page 324 and will therefore deliver it to the requester. See references 618 and 620 respectively. The recipient 212 might then read the published web page 234.

Note also that the website 300 can be configured to gather demographic data during all or portions of the process 600. Although, the website 300 need not do so. Nonetheless, website 300 can log the demographic data (if any) it has gathered in an e-commerce database 317 (see FIG. 3). See reference 622. Whether website 300 gathers such demographic data or not, process 600 can repeat in whole or in part as indicated by reference 624.

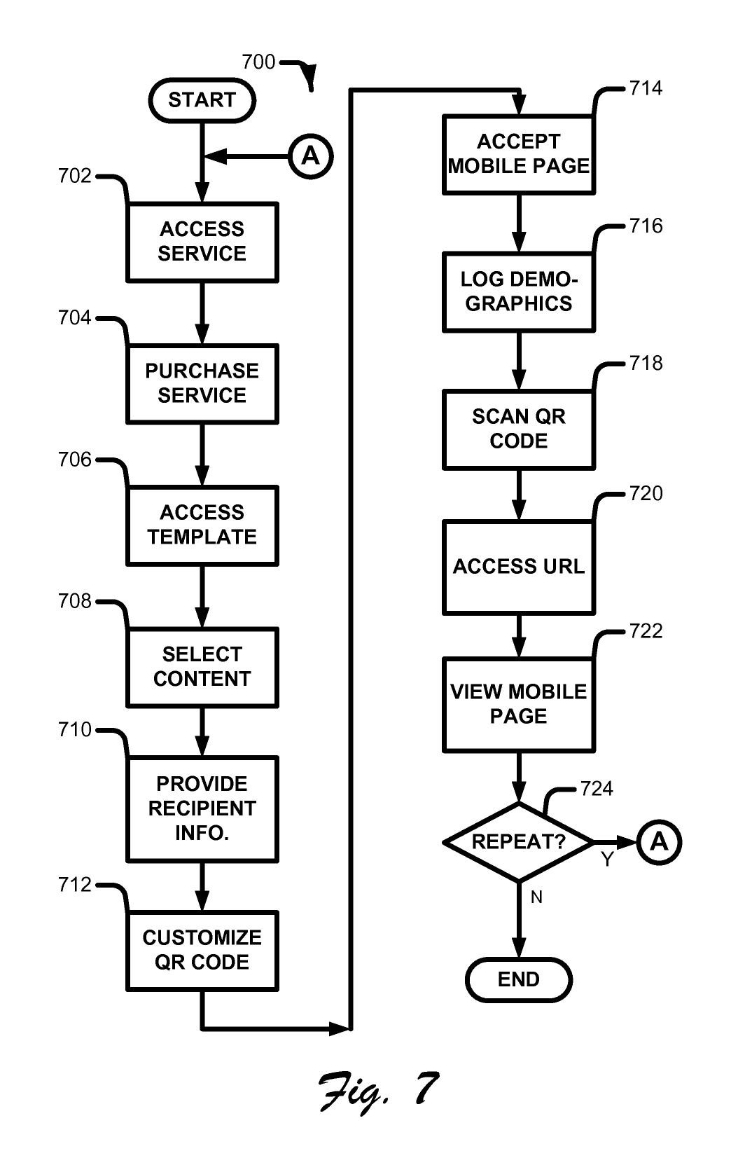

FIG. 7 illustrates an example process for creating and receiving mobile content. The process 700 of the current embodiment can include accessing the website 300 and its associated services, functionality, etc. See reference 702. The user 208 can elect to purchase web page building services from the website 300 as illustrated by reference 704. Moreover, the user 208 can then access the templates 400 and begin selecting and uploading content thereto. See references 706 and 708. At some point, the user 208 can provide the website 300 information regarding the intended recipient 212. That information can include the identity, the street address, the mailing address, the email address, etc. of the recipient 212. See reference 710.

In some cases, a user 208 might desire to customize a 2D-code icon 114. Thus, the user 208 selects from among various customization options presented by the website 300 (or template 400). These options include, in the current embodiment, color modifications, size modifications, adding/inserting artwork, etc. Another option includes embedding a monogram or other graphical element into the 2D-code icon 114. The monograms include personal, family, and corporate monograms although other types of monograms are within the scope of the current disclosure. See reference 712. Reference 714 indicates that the user 208 can accept the web page when they have completed building it or at other times.

The acceptance of the web page can cause the website 300 to publish it as a published web page 324. This can mean that the website 300 activates an URL associated with the published web page 324. As a result, should a recipient 212 scan an instance of the 2D-code icon 114 and visit the corresponding URL, the URL will return the published web page 324 to the recipient 212. Accordingly, the website 300 can begin gathering demographic information from any recipients 212 that might visit the URL. See reference 716.

With continuing reference to FIG. 7, it is likely that at some point a recipient will actually scan the 2D-code icon 114 as indicated at reference 718. They will then be able to access the URL and view the published web page 324. See references 720 and 722 respectively. Moreover, as indicated at reference 724, the process 700 can repeat in whole or in part as might be desired.

Embodiments and implementations allow users to customize greeting cards by linking the same to web pages via 2D codes. Recipients of such customized 2D greeting cards can access the customized content by reading 2D codes in the greeting cards with a mobile device. Accordingly, much more content can be associated with a 2D greeting card of the current embodiment than with conventional greeting cards.

### Additional and Alternative Implementation Notes

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, processes, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that can be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

Unless the context indicates otherwise, the term “logic” used herein includes hardware, software, firmware, circuitry, logic circuitry, integrated circuitry, other electronic components and/or a combination thereof that is suitable to perform the functions described for that logic.

### Examples Illustrating Implementations

The following are paragraphs that provide details about different implementations.

Example implementations include a method, system, and/or computer-readable media with necessary instructions to perform the following operations:
makes a web-page-creation website available to a customer;
accepts content selected by the customer for customizing a web page via the web-page-creation website;
builds the customized web page based upon the accepted user-selected content;
facilitates a generation of a two-dimensional (2D) code (e.g., QR™ code), the 2D code including a link to the customized web page;
facilitates production of a 2D-code icon by a third party (e.g., a florist), wherein the third party produces a 2D-code icon containing the 2D code, wherein the 2D-code icon supplies the link to the customized web page when scanned by a device configured to scan such 2D-code icons.

In some of the above implementations, the third party prints the 2D-code icon on a card or label for attachment to a to-be-delivered gift. In addition, some implementations facilitate delivery of the printed 2D-code icon to a gift recipient. That may mean providing instructions, maps, directions, or any aid that helps in the delivery of the gift.

In alternative implementations, the facilitating the 2D code generation discussed above might include (but not be limited to)
generating the 2D code;
obtaining the 2D code; or
sending information about linking to the customized web page to the third party, wherein the third party generates the 2D code.

In alternative implementations, the facilitating production of a 2D-code icon by a third party discussed above might include (but not be limited to)
generating the 2D-code icon and sending that 2D-code icon to the third party, wherein the third party prints the 2D-code icon; or
sending a generated 2D code to the third party, wherein the third party generates the 2D-code icon from the 2D code.

In alternative implementations, the gift recipient scans the 2D code icon via their mobile device. That device sends a request to load the associated customized web page. The servers receive a request to send the customized web page to a client device (e.g., mobile device). In response to that request, the server sends the customized web page to the client device.

In still other implementations (which may be called “retail”), the customer prints out a copy of the 2D-code icon using her own printer. The icon may be printed on a card or a label and then affixed/attached to a to-be-delivered gift. The customer delivers or has the gift delivered (e.g., via the U.S. Post Office) with the 2D-code icon card/label.

What is claimed is:

1. A process comprising:
making a web-page-creation website available to a customer;
accepting content selected by the customer for customizing a web page via the web-page-creation website;
building the customized web page based upon the accepted user-selected content;
facilitating a generation of a two-dimensional (2D) code, the 2D code including a link to the customized web page;
facilitating production of a 2D-code icon by a third party, wherein the third party produces a 2D-code icon containing the 2D code, wherein the 2D-code icon supplies the link to the customized web page when scanned by a device configured to scan such 2D-code icons.

2. A process as recited by claim 1, wherein the third party prints the 2D-code icon on a card or label for attachment to a to-be-delivered gift.

3. A process as recited by claim 1, wherein facilitating the 2D code generation includes:
generating the 2D code;
obtaining the 2D code; or
sending information about linking to the customized web page to the third party, wherein the third party generates the 2D code.

4. A process as recited by claim 1, wherein facilitating production of a 2D-code icon by a third party includes:
generating the 2D-code icon and sending that 2D-code icon to the third party, wherein the third party prints the 2D-code icon; or
sending a generated 2D code to the third party, wherein the third party generates the 2D-code icon from the 2D code.

5. A process as recited by claim 1 further comprising facilitating delivery of the printed 2D-code icon to a gift recipient.

6. A process as recited by claim 1 further comprising:
receiving a request to send the customized web page to a client device;
sending the customized web page to the client device responsive to the request.

7. The process as recited by claim 1, wherein the 2D-code icon customization contains a monogram.

8. One or more computer-readable media having computer-executable instructions stored thereon that, when executed by one or more computers, direct the one or more computers to perform an operation comprising:
making a web-page-creation website available to a customer;
accepting content selected by the customer for customizing a web page via the web-page-creation website;
building the customized web page based upon the accepted user-selected content;
facilitating an acquisition of a two-dimensional (2D) code, the 2D code including a link to the customized web page;
facilitating production of a 2D-code icon by a third party, wherein the third party produces a 2D-code icon containing the 2D code, wherein the 2D-code icon supplies the link to the customized web page when scanned by a device configured to scan such 2D-code icons.

9. One or more computer-readable media as recited by claim 8, wherein the third party prints the 2D-code icon on a card or label for attachment to a to-be-delivered gift.

10. One or more computer-readable media as recited by claim 9, the operations further comprising facilitating delivery of the printed 2D-code icon to a gift recipient.

11. One or more computer-readable media as recited by claim 8, wherein facilitating the 2D code acquisition includes:
generating the 2D code;
obtaining the 2D code; or
sending information about linking to the customized web page to the third party, wherein the third party generates the 2D code.

12. One or more computer-readable media as recited by claim 8, wherein facilitating production of a 2D-code icon by a third party includes:
generating the 2D-code icon and sending that 2D-code icon to the third party, wherein the third party prints the 2D-code icon; or
sending a generated 2D code to the third party, wherein the third party generates the 2D-code icon from the 2D code.

13. One or more computer-readable media as recited by claim, the operations further comprising:
receiving a request to send the customized web page to a client device;
sending the customized web page to the client device responsive to the request.

14. One or more computer-readable media as recited by claim 8, wherein the 2D-code icon contains a monogram.

15. One or more computer-readable media as recited by claim 8, wherein the building of the web page further comprises providing a template.

16. One or more computer-readable media as recited by claim 8, the operations further comprising accepting a monogram and customizing the 2D-code icon with the monogram.

17. One or more computer-readable media as recited by claim 16, wherein the monogram is a monogram selected from the group consisting of a company monogram, a family monogram, and a personal monogram.

18. A system comprising:
one or more servers configured to be in communication with a wide area network, the one or more servers being further configured to:
make a web-page-creation website available to a customer via the wide area network;
accept content selected by the customer for a customized web page via the page creation website;
build the customized web page using the user-selected content;
associate a two-dimensional (2D) code with the customized web page;
facilitate delivery of a printed 2D-code icon to a gift recipient.

19. The system as recited by claim 18, wherein the one or more servers is further configured to accept a customization of the 2D-code icon.

20. The system as recited by claim 20, wherein the one or more servers is further configured to store templates for the customized web page and is further configured to build the web page using one or more of the stored templates.
